(19) United States
(12) Patent Application Publication
(10) Pub. No.: US 2021/0317766 A1
(43) Pub. Date: Oct. 14, 2021

(54) EXHAUST GAS PURIFICATION DEVICE, ASSOCIATED EXHAUST LINE AND PURIFICATION METHOD

(71) Applicant: FAURECIA SYSTEMES D'ECHAPPEMENT, NANTERRE (FR)

(72) Inventors: Christophe VIAULT, BELFORT (FR); Vincent LEBOURGEOIS, VOUJEAUCOURT (FR)

(21) Appl. No.: 17/223,077

(22) Filed: Apr. 6, 2021

(30) Foreign Application Priority Data
Apr. 8, 2020 (FR) 20 03520

(51) Int. Cl. F01N 3/20; F01N 3/28; F01N 3/10; B01D 53/94

(52) U.S. Cl. CPC F01N 3/2066; F01N 3/2892; F01N 3/2006; F01N 2610/10; B01D 53/9418; B01D 53/9431; F01N 2610/1453; F01N 3/105

(57) ABSTRACT

An exhaust gas purification device comprises a conduit defining a flow passage for exhaust gases. The exhaust gas purification device comprises at least one purification unit, where each purification unit is arranged in the conduit and comprises an exhaust gas purification component arranged in the flow passage and at least one mixer arranged upstream of the exhaust gas purification component. The exhaust gas purification device comprises at least one injector arranged to inject a reducing agent into the flow passage. The exhaust gas purification device comprises a heating element for heating the exhaust gas and the reducing agent, with the heating element being arranged upstream of the mixer of the purification unit or one of the purification units.

### CROSS-REFERENCE TO RELATED APPLICATIONS

This application is a U.S. non-provisional application claiming the benefit of French Application No. 20 03520, filed on Apr. 8, 2020, which is incorporated herein by reference in its entirety.

### TECHNICAL FIELD

The present disclosure relates to an exhaust gas purification device, comprising a conduit defining an exhaust gas flow passage, the conduit having an upstream end and a downstream end and being shaped to conduit exhaust gas from the upstream end to the downstream end, The exhaust gas purification device comprises at least one purification unit, the or each purification unit being arranged in the conduit and comprising an exhaust gas purification component arranged in the exhaust gas flow passage, and at least one mixer arranged upstream of the exhaust gas purification component. The purification device comprises at least one injector arranged to inject a reducing agent into the flow passage.

### BACKGROUND

Exhaust gas purification devices are mainly used in vehicles with internal combustion engines, such as motor vehicles, for example.

Motor vehicle internal combustion engines are known to produce nitrogen oxides, also known as “NOx”. These can be a significant source of air pollution since they contribute to the formation of acid fog and rain and affect ground-level ozone. It is therefore desirable to eliminate the NOx contained in the exhaust gases from these engines.

To this end, a method known as “Selective Catalytic Reduction” (SCR) has been developed, in which ammonia is used to reduce NOx to harmless particles such as nitrogen dioxide N₂ and water H₂O. The most common way to carry out this method is to inject a liquid urea-based agent into the exhaust conduit, which will be mixed with the exhaust gas and decomposed to turn into ammonia, before the mixture of exhaust gas and ammonia passes through a purification component in which the ammonia reduces the NOx to dinitrogen.

Each purification component is specifically designed to accumulate a quantity of ammonia formed from the reducing agent.

In order to improve the purification performance of the purification device, and in particular to increase the ammonia accumulation capacity of this device, it is known to use a device comprising two purification components, called the upstream purification component and downstream purification component.

However, such a purification device is not entirely satisfactory. In effect, the exhaust gas and the reducing agent tend to cool down along the exhaust conduit and the temperature of the mixture of exhaust gas and reducing agent does not always allow for a high accumulation of ammonia formed from the reducing agent in the purification components and/or good processing of the exhaust gas by the purification components.

### SUMMARY

An exhaust gas purification device is provided that has improved performance, and is capable of injecting a larger quantity of reducing agent, in particular for all operating regimes of the engine generating the exhaust gases.

For this purpose, the disclosure relates to an exhaust gas purification device, wherein the purification device comprises a heating element for heating the exhaust gas and the reducing agent, the heating element being arranged upstream of the mixer of the purification unit or of one of the purification units.

The use of a heating element upstream of a mixer is particularly advantageous for improving the evaporation capacity of the injected reducing agent. Such a purification device then provides improved purification performance even when the temperature of the exhaust gas entering the purification device is low.

According to particular embodiments of the disclosure, the exhaust gas purification device comprises one or more of the following characteristics, taken alone or in any technically possible combination:

the purification device comprises at least two purification units, at least one of the purification units having a heating element, the purification device having at least two injectors;

the heating element comprises a catalytic coating layer, the heating element being intended for purifying the exhaust gases;

the heating element comprises a metal foam, the foam being intended for heating the exhaust gases;

the device comprises two purification units, referred to as an upstream unit and a downstream unit, the upstream unit comprising a first injector, the first injector being arranged upstream of the purification component of the upstream unit, the downstream unit comprising a second injector and the heating element, the second injector being arranged upstream of the purification component of the downstream unit, the heating element being arranged between the second injector and the purification component of the downstream unit;

the device comprises two purification units referred to as the upstream unit and the downstream unit, the upstream unit having a first injector, a second injector and the heating element, the first injector being arranged upstream of the purification component of the upstream unit, the second injector being arranged downstream of the purification component of the upstream unit, the heating element being arranged between the purification component of the upstream unit and the second injector; and

the device comprises two purification units referred to as the upstream unit and the downstream unit, the upstream unit comprising a first injector, a second injector and the heating element, the first injector being arranged upstream of the purification component of the upstream unit, the heating element being arranged downstream of the purification component of the upstream unit, the second injector being arranged between the purification component of the upstream unit and the heating element.

The disclosure further relates to an exhaust line having an internal combustion engine and an exhaust gas purification device as described.

The disclosure further relates to a vehicle having such an exhaust line.

The disclosure also relates to an exhaust gas purification method implemented by a purification device as described, comprising a cold purification step in which the first injector and the second injector inject the reducing agent, the heating element then being activated to heat the exhaust gases circulating in the conduit.

According to particular embodiments of the disclosure, the purification method comprises one or more of the following features, considered alone or according to all technically possible combinations:

the purification method, following the cold purification step, comprises a transition purification step in which only the second injector injects the reducing agent, the heating element then being activated to heat the exhaust gases circulating in the conduit; and

the purification method, following the transition purification step, comprises a hot purification step in which only the second injector injects the reducing agent, the heating element then being deactivated by not heating the exhaust gases circulating in the conduit.

### BRIEF DESCRIPTION OF THE DRAWINGS

Other features and advantages of the disclosure will appear upon reading the following description, given only as an example and with reference to the appended drawings, in which:

FIG. 1 is a schematic representation of a vehicle having an exhaust line according to the disclosure;

FIG. 2 is a schematic representation of a purification device according to a first embodiment of the disclosure;

FIG. 3 is a schematic representation of a purification device according to a second embodiment of the disclosure;

FIG. 4 is a schematic representation of a purification device according to a third embodiment of the disclosure; and

FIG. 5 is a flowchart of an exhaust gas purification method according to the disclosure.

### DETAILED DESCRIPTION

In the following description, the terms upstream and downstream are defined in terms of a direction of flow of a fluid from a source, an upstream point being closer to the source of the flow than a downstream point. A “temperature around” is defined as a temperature within a range of plus or minus 10° C. around the quoted temperature.

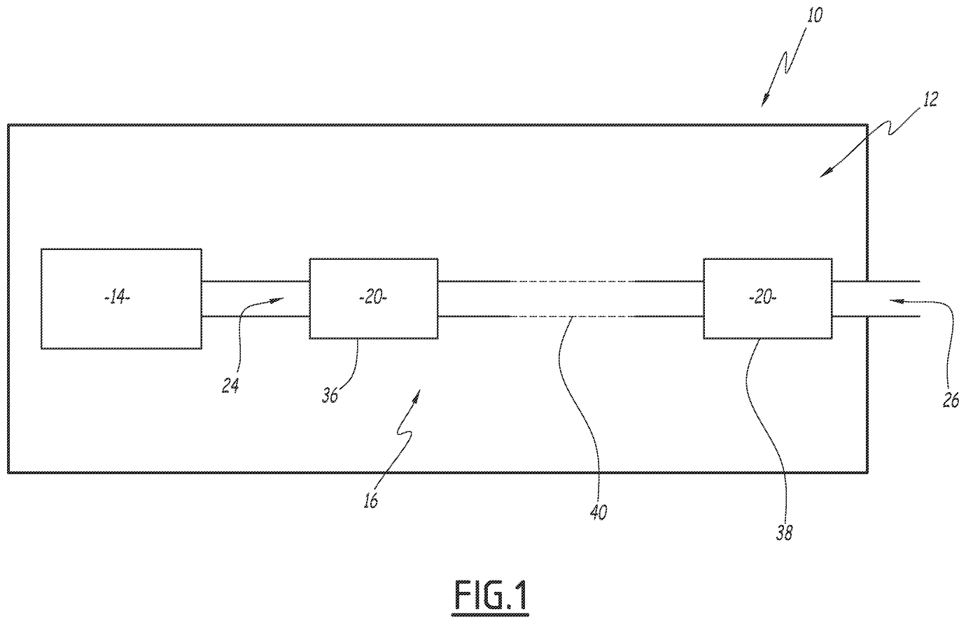

FIG. 1 shows a vehicle 10 having an exhaust line 12. The exhaust line 12 is, for example, suitable for handling the exhaust of an internal combustion engine 14, such as a diesel engine.

The exhaust line 12 is an exhaust line of a vehicle 10 for example, in particular of a motor vehicle such as a car, bus or truck. Alternatively, the exhaust line 12 is an exhaust line of a fixed installation.

The exhaust line 12 has an exhaust gas purification device 16.

The exhaust gas purification device 16 is intended to treat the exhaust gas of the internal combustion engine 14 and, for example, to remove NOx from the exhaust gas of engine 14.

The purification device 16 comprises a conduit 18, at least one purification unit 20 and at least one injector, preferably two injectors, referred to as the first injector 42 and the second injector 44.

The conduit 18 has an upstream end 24 and a downstream end 26.

The upstream end 24 is for example connected to the internal combustion engine 14. Alternatively, the upstream end 24 is connected to an additional purification device (not shown).

For example, the downstream end 26 leads to an exterior of the vehicle 10. Alternatively, the downstream end 26 leads to an additional purification device (not shown).

The conduit 18 defines an exhaust gas flow passage 28 extending between the upstream end 24 and the downstream end 26. The flow passage 28 is shaped to conduct exhaust gases from the upstream end 24 of the conduit 18 to the downstream end 26 of the conduit 18.

Each purification unit 20 is arranged in the conduit 18. Each purification unit 20 consists of a purification component 30, at least one mixer 32, and a holding mat 33.

The purification unit 16 includes a heating element 34.

In particular, in the variant according to which the purification device 16 comprises a plurality of purification units 20, at least one of the purification units 20 comprises, for example, a heating element 34.

At least one of the purification units 20 includes one of the injectors 42, 44 of the purification device 16.

For example, each holding mat 33 is arranged on the periphery of the purification unit 20 of which it is a part and radially connects the purification unit 20 in the conduit 18.

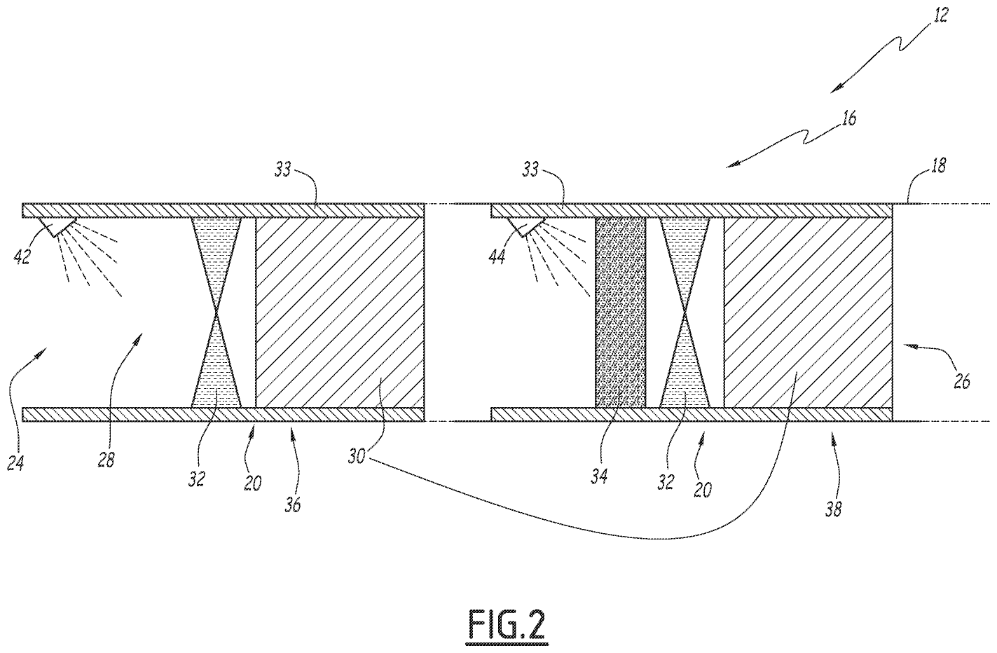

In each of the variants shown in FIGS. 2 to 4, the purification device 16 comprises two injectors 42, 44, two purification units 20, and a heating element 34.

One of the two purification units 20 is referred to as the upstream unit 36 and is located upstream of the other purification unit 20, referred to as the downstream unit 38.

The upstream unit 36 and the downstream unit 38 are connected by a connecting section 40. The upstream unit 36 and the downstream unit 38 are preferably more than 250 mm apart along conduit 18. In particular, the distance between the upstream unit 36 and the downstream unit 38 is between 250 mm and 2000 mm.

In a variant not shown, an additional purification device is arranged between the upstream unit 36 and the downstream unit 38.

The length of the upstream unit 36 and the length of the downstream unit 38 along the conduit 18 is preferably between 50 mm and 300 mm.

Each injector 42, 44 is arranged to inject a reducing agent into the flow passage 28, the reducing agent being shown schematically by dotted lines connected to the injectors 42, 44 in FIGS. 2 to 4. The reducing agent is intended in particular to reduce the NOx contained in the exhaust gas into harmless N2 dinitrogen.

In the variant shown in FIG. 2, the upstream unit 36 comprises the first injector 42, the first injector 42 being arranged upstream of the purification component 30 of the upstream unit 36, and the downstream unit 38 comprises the second injector 44, the second injector 44 being arranged upstream of the purification component 30 of the downstream unit 38.

In the variant shown in FIG. 2, the first injector 42 and the second injector 44 are configured to inject the reducing agent towards a center of the conduit 18, for example with a component in an upstream to downstream direction.

Each purification component 30 is arranged in the exhaust gas flow passage 28.

The purification component 30 is preferably a selective catalytic reduction substrate, later referred to as an SCR (Selective Catalytic Reduction) substrate. The purification component 30 is a ceramic SCR substrate, for example.

The purification component 30 is intended to accumulate the reducing agent injected from at least one of the injectors 42, 44 and to purify the exhaust gas with the absorbed reducing agent. The reducing agent is, for example, absorbed as a result of decomposition, transforming the reducing agent into ammonia, for example.

Each mixer 32 of each purification unit 20 is placed upstream of the purification component 30 of said purification unit 20.

Each mixer 32 is placed downstream of one of the injectors 42, 44. In the variant of FIG. 2, the mixer 32 of the upstream unit 36 is placed downstream of the first injector 42 and the mixer 32 of the downstream unit 38 is placed downstream of the second injector 44.

Each mixer 32 is suitable for increasing the turbulence of the exhaust gas circulating through the flow passage 28.

The mixer 32 is intended to disrupt the flow of exhaust gas and reducing agent in order to homogenize the mixture of the reducing agent and the exhaust gas.

The mixer 32, for example, has a large number of vanes that interfere with the flow of exhaust gas.

The heating element 34 is intended to heat the exhaust gas and the reducing agent, particularly upstream of a purification component 30.

The heating element 34 is arranged upstream of the mixer 32 of the purification unit 20 or one of the purification units 20.

The heating element 34 comprises a metal foam extending into the flow passage 28 and is intended for heating the exhaust gas and the reducing agent, circulating through the metal foam by forced convection and radiation, for example.

Preferably, the metal foam is made of an Iron/Chromium/Aluminum alloy (FeCrAl) or a Nickel/Chromium alloy (NiCr). The metal foam has a density of between 8 and 11%, and a thickness, measured axially along the conduit 18, of between 5 and 50 mm, preferably between 15 and 30 mm.

The metal foam is, for example, intended to be passed through by an electric current in order to heat up by Joule effect and thus to heat up the exhaust gases and the reducing agent.

The maximum electrical power supplied to the heating element 34 is, for example, between 1 kW and 5 kW, preferably between 2 and 4 kW.

The heating element 34 preferably has a catalytic coating. The heating element 34 is, for example, intended to purify exhaust gases.

In the variant shown in FIG. 2, the downstream unit 38 comprises the heating element 34. The heating element 34 is then arranged between the second injector 44 and the purification component 30 of the downstream unit 38. In particular, the heating element 34 is placed between the second injector 44 and the mixer 32 of the downstream unit 38, axially along the conduit 18. The heating element 34 is then suitable for heating the exhaust gas and the reducing agent injected by the second injector 44, before the mixture of exhaust gas and reducing agent is homogenized by the mixer 32 of the downstream unit 38 and then purified by the purification component 30 of the downstream unit 38.

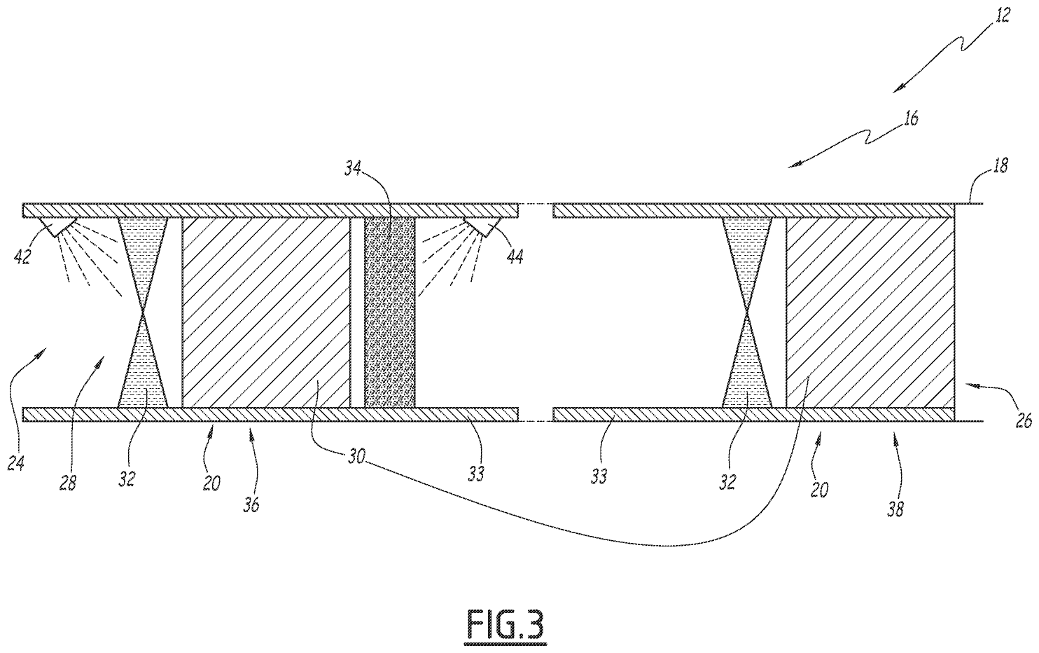

The variant illustrated in FIG. 3 differs from the variant illustrated in FIG. 2 only in the following. Similar components have the same references.

The upstream unit 36 includes heating element 34 and the downstream unit 38 does not include the heating element 34. The upstream unit 36 includes the second injector 44 and the downstream unit 38 does not include a second injector 44. The first injector 42 is located upstream of the purification component 30 of the upstream unit 36 and the second injector 44 is located downstream of the purification component 30 of the upstream unit 36. The heating element 34 is arranged between the purification component 30 of the upstream unit 36 and the second injector 44.

The upstream unit 36 then comprises successively, from its upstream end to its downstream end: the first injector 42, the mixer 32 of the upstream unit 36, the purification component 30 of the upstream unit 36, the heating element 34 and the second injector 44.

The downstream unit 38 then comprises successively, from its upstream end to its downstream end: the mixer 32 of the downstream unit 38 and the purification component 30 of the downstream unit 38.

The first injector 42 and the second injector 44 are configured to inject the reducing agent towards a center of the conduit 18, the first injector 42, for example, with a component in an upstream to downstream direction and the second injector 44, for example, with a component in a downstream to upstream direction.

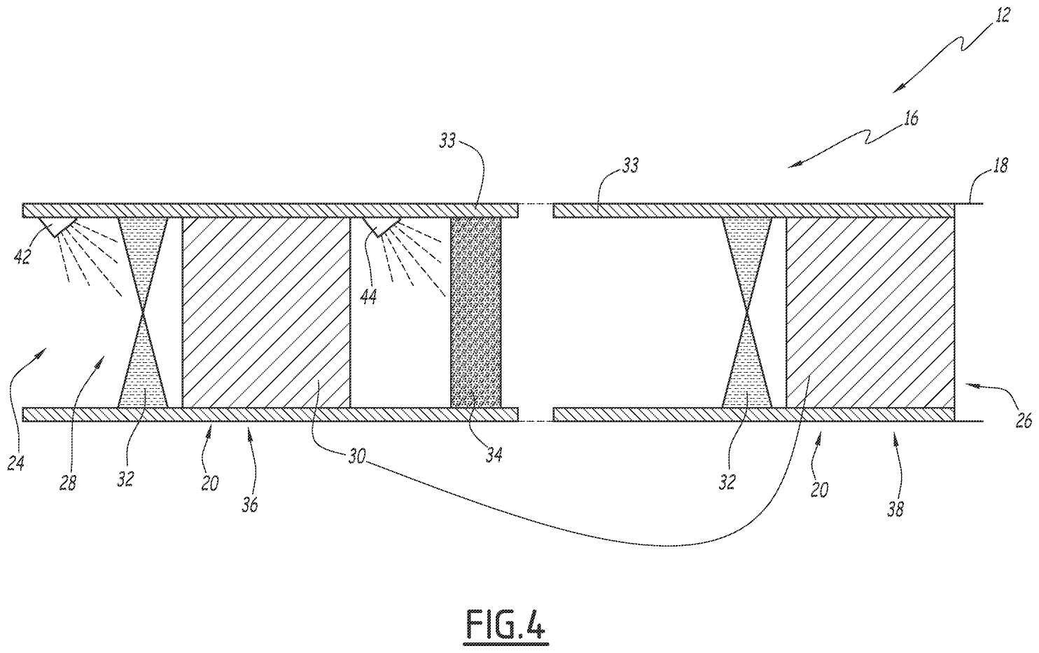

The variant illustrated in FIG. 4 differs from the variant illustrated in FIG. 3 only by the following. Similar components have the same references.

The second injector 44 is arranged upstream of the heating element 34, so that it is arranged in the upstream unit 36 between the purification component 30 of the upstream unit 36 and the heating element 34.

The upstream unit 38 then comprises successively, from its upstream end to its downstream end: the first injector 42, the mixer 32 of the upstream unit 36, the purification component 30 of the upstream unit 36, the second injector 44 and the heating element 34.

The downstream unit 38 then comprises successively, from its upstream end to its downstream end: the mixer 32 of the downstream unit 38 and the purification component 30 of the downstream unit 38.

The first injector 42 and the second injector 44 are configured to inject the reducing agent towards a center of conduit 18, for example with a component in an upstream to downstream direction.

In a variant not shown, the purification device 16 comprises only one purification unit 20 and only one injector 44. According to this variant, the heating element 34 is, for example, arranged in the conduit 18 upstream of the purification unit 20. Alternatively, the purification unit 20 comprises the heating element 34 which is arranged in this purification unit 20 upstream of the mixer 32.

An exhaust gas purification method 100 implemented by an exhaust gas purification device 16 as previously described will now be presented. The purification device 16 is, for example, installed in a vehicle 10 as previously described.

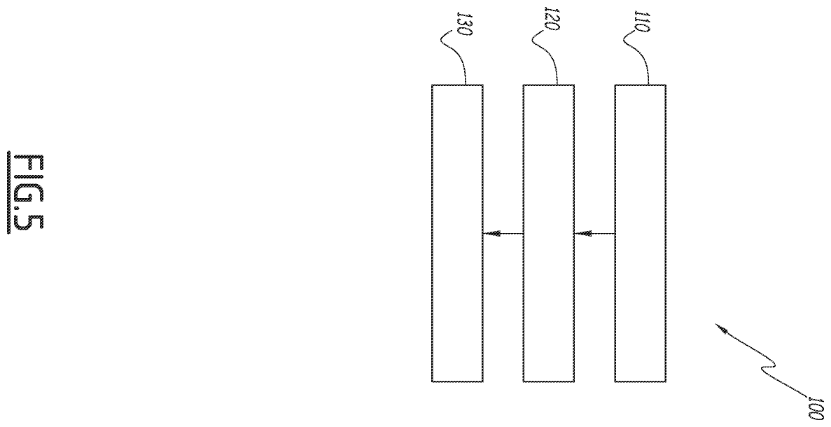

The method 100, shown in FIG. 5, comprises a cold purification step 110, advantageously followed by a transition purification step 120, and a hot purification step 130.

When the temperature of the exhaust line 12 is low, for example after starting the internal combustion engine 14, the exhaust gas temperature is low and decreases rapidly along the exhaust line 12. When the temperature in the exhaust line 12 is low, the evaporation capacity of the mixer 32 of the purification unit 20 is low and little of the reducing agent, for example converted into ammonia, can be absorbed by the purification component(s) 30. The cold purification step 110 is then initiated.

In the cold purification step 110, the first injector 42 injects reducing agent into the exhaust gas flow passage 28. The heating element 34 is then activated to heat the exhaust gas and the reducing agent circulating in the conduit 18.

The exhaust gases generated by the internal combustion engine 14 are mixed with the reducing agent injected by the first injector 42 using the mixer 32 of the upstream unit 36. Despite the absence of a heating element 34 in the upstream unit 36, the proximity between the upstream unit 36 and the internal combustion engine 14 ensures a rapid rise in the temperature of the exhaust gases and the reducing agent injected into the upstream unit 36. The exhaust gases are then partially purified in the upstream unit 36. The quantity of reducing agent injected by the first injector 42 is, for example, adapted to improve the purification of the exhaust gas and the accumulation of reducing agent in the purification component(s) 30 while limiting the crystallization of the reducing agent in the form of deposits in the exhaust line 12.

A second injection of reducing agent into the exhaust gas is possible in parallel, when the temperature of the downstream unit 38 is sufficient, for example at approximately 250° C., via the second injector 44, into the exhaust gas leaving the purification component 30 of the upstream unit 36. The mixture of the exhaust gas and the second injection is heated by the heating element 34 before it is mixed by the mixer 32 of the downstream unit 38 and processed by the purification component 30 of the downstream unit 38.

For example, the heating element 34 is heated to a temperature between 250° C. and 500° C., for example around 400° C., so that the mixture of exhaust gas and reducing agent enters the purification component 30 of the downstream unit 38 at a temperature between 250° C. and 500° C., for example around 400° C.

The quantity of reducing agent injected by the second injector 44 and the heating developed by the heating element 34 are, for example, adapted to improve the purification of the exhaust gas and the accumulation of reducing agent in the purification component 30 of the downstream unit 38 while limiting the crystallization of the reducing agent in the form of deposits in the exhaust line 12.

Following the cold purification step 110, that is, when the exhaust line 12 reaches an excessive temperature at its upstream end, for example, when the exhaust gas temperature exceeds 450° C. on entering the purification component 30 of the upstream unit 36, and the temperature of the exhaust line 12 is sufficient at its downstream end 26, for example, when the exhaust gas temperature exceeds 250° C. on entering the downstream unit 38, the transition purification step 120 is initiated.

In the transition purification step 120, only the second injector 44 injects the reducing agent. The first injector 42 does not inject any reducing agent, as the temperature of the exhaust gas flowing into the purification component 30 of the upstream unit 36 is too high for effective exhaust gas purification. However, the heating element 34 is activated to heat the exhaust gas flowing downstream of the upstream unit 36, the temperature of the exhaust gas in the purification member 30 of the downstream unit 38 being sufficient for optimal operation of the purification element 30 of the downstream unit 38.

For example, the heating element 34 is heated to a temperature of between 300° C. and 500° C., for example around 400° C., so that the mixture of exhaust gas and reducing agent penetrates in larger quantities into the purification component 30 of the downstream unit 38 at a temperature of between 300° C. and 500° C., for example around 400° C.

The quantity of reducing agent injected by the second injector 44 and the heating developed by the heating element 34 are suitable, for example, for improving the purification of the exhaust gas and the accumulation of reducing agent in the purification component 30 of the downstream unit 38, while at the same time limiting the crystallization of the reducing agent in the form of deposits in the exhaust line 12.

Following the transition purification step 120, that is, when the exhaust line 12 reaches an excessive temperature at its upstream end, for example, when the temperature of the exhaust gas exceeds 450° C. on entering the purification component 30 of the upstream unit 36, and the temperature of the exhaust line 12 is sufficient at its downstream end, for example, when the temperature of the exhaust gas exceeds 250° C. on entering the purification unit 30 of the downstream unit 38, the hot purification step 130 is initiated.

In the hot purification step 130, only the second injector 44 injects the reducing agent. The first injector 42 does not inject any reducing agent, as the temperature of the exhaust gas flowing into the purification component 30 of the downstream unit 38 is too high for effective purification of the exhaust gas. The heating element 34 is then deactivated by not heating the exhaust gas flowing through the conduit 18, the temperature of the exhaust gas in the purification component 30 of the downstream unit 38 being sufficient for the proper functioning of the purification component 30 of the downstream unit 38, allowing for example a high evaporation of the reducing agent injected by the second injector 44.

A purification device 16 as previously described including a heating element 34 is particularly advantageous since it improves the performance of the purification device 16 by improving the control of the exhaust gas temperature along the conduit 18.

The use of a heating element 34 having a catalytic coating layer ensures improved exhaust gas purification.

A heating element 34 having a metallic foam is particularly suitable for heating the exhaust gases and the reducing agent efficiently and evenly while limiting the pressure drops in the exhaust conduit 18.

The use of two purification units 20 arranged at different levels of the conduit 18 allows better temperature control at the purification units 20, with the upstream purification unit 36 being naturally hotter than the downstream purification unit 38.

A downstream purification unit 38 with the second injector 44 ensures good control of the amount of reducing agent injected into the downstream purification unit 38 as well as its temperature.

An upstream purification unit 36 comprising the first injector 42 and the second injector 44 is particularly advantageous for reducing the footprint of the downstream purification unit 38, while maintaining efficient exhaust gas purification.

The purification unit 16 preferably comprises a single heating element 34. The heating element 34 is, for example, located between the purification component 30 of the upstream unit 36 and the purification component 30 of the downstream unit 38.

The heating element 34 is preferably arranged upstream of the mixer 32 of the downstream unit 38.

Although various embodiments have been disclosed, a worker of ordinary skill in this art would recognize that certain modifications would come within the scope of this disclosure. For that reason, the following claims should be studied to determine the true scope and content of this disclosure.

1. An exhaust gas purification device comprising a conduit defining an exhaust gas flow passage for exhaust gas, the conduit having an upstream end and a downstream end and being shaped to conduct exhaust gas from the upstream end to the downstream end, the exhaust gas purification device having at least one purification unit, each purification unit being arranged in the conduit and comprising:
an exhaust gas purification component arranged in the exhaust gas flow passage;
at least one mixer arranged upstream of the exhaust gas purification component;
the exhaust gas purification device having at least one injector arranged to inject a reducing agent into the exhaust gas flow passage;
wherein the exhaust gas purification device comprises a heating element configured to heat the exhaust gases and the reducing agent, the heating element being arranged upstream of the at least one mixer of the at least one purification unit or of one of the purification units;
wherein the at least one purification unit comprises at least two purification units, at least one of the at least two purification units having the heating element; and the at least one injector comprises at least two injectors; and
wherein the heating element is arranged between the exhaust gas purification components of the at least two purification units upstream of the at least one mixer of a downstream purification unit of the at least two purification units.

2. The exhaust gas purification device according to claim 1, wherein the heating element comprises a metal foam, the metal foam being intended to heat the exhaust gases.

3. The exhaust gas purification device according to claim 1, wherein the at least two purification units comprise an upstream purification unit and the downstream purification unit, the upstream purification unit having a first injector of the at least two injectors, the first injector being arranged upstream of the exhaust gas purification component of the upstream purification unit, the downstream purification unit having a second injector of the at least two injectors and the heating element, the second injector being arranged upstream of the exhaust gas purification component of the downstream purification unit, the heating element being arranged between the second injector and the exhaust gas purification component of the downstream purification unit.

4. The exhaust gas purification device according to claim 1, wherein the at least two purification units comprise an upstream purification unit and the downstream purification unit, the upstream purification unit having a first injector of the at least two injectors, a second injector of the at least two injectors, and the heating element, the first injector being arranged upstream of the exhaust gas purification component of the upstream purification unit, the second injector being arranged downstream of the exhaust gas purification component of the upstream purification unit, the heating element being arranged between the exhaust gas purification component of the upstream purification unit and the second injector.

5. The exhaust gas purification device according to claim 1, wherein the at least two purification units comprise an upstream purification unit and the downstream purification unit, the upstream purification unit having a first injector of the at least two injectors, a second injector of the at least two injectors, and the heating element, the first injector being arranged upstream of the exhaust gas purification component of the upstream purification unit, the heating element being arranged downstream of the exhaust gas purification component of the upstream purification unit, the second injector being arranged between the exhaust gas purification component of the upstream purification unit and the heating element.

6. An exhaust line having an internal combustion engine and the exhaust gas purification device for purifying the exhaust gases according to claim 1.

7. A vehicle having the exhaust line according to claim 6.

8. An exhaust gas purification method implemented by the exhaust gas purification device according to claim 3, having a cold purification step in which the first injector and the second injector inject the reducing agent, the heating element then being activated to heat the exhaust gas circulating through the conduit.

9. An exhaust gas purification method implemented by the exhaust gas purification device according to claim 4, having a cold purification step in which the first injector and the second injector inject the reducing agent, the heating element then being activated to heat the exhaust gas circulating through the conduit.

10. An exhaust gas purification method implemented by the exhaust gas purification device according to claim 5, having a cold purification step in which the first injector and the second injector inject the reducing agent, the heating element then being activated to heat the exhaust gas circulating through the conduit.

11. The exhaust gas purification method according to claim 8, comprising, following the cold purification step, a transition purification step in which only the second injector injects the reducing agent, the heating element then being activated to heat the exhaust gases circulating through the conduit.

12. The exhaust gas purification method according to claim 9, comprising, following the cold purification step, a transition purification step in which only the second injector injects the reducing agent, the heating element then being activated to heat the exhaust gases circulating through the conduit.

13. The exhaust gas purification method according to claim 10, comprising, following the cold purification step, a transition purification step in which only the second injector injects the reducing agent, the heating element then being activated to heat the exhaust gases circulating through the conduit.

14. The purification method according to claim 11, comprising, following the transition purification step, a hot purification step in which only the second injector injects the reducing agent, the heating element then being deactivated by not heating the exhaust gases circulating in the conduit.

15. The exhaust gas purification method according to claim 12, comprising, following the transition purification step, a hot purification step in which only the second injector injects the reducing agent, the heating element then being deactivated by not heating the exhaust gases circulating in the conduit.

16. The exhaust gas purification method according to claim 13, comprising, following the transition purification step, a hot purification step in which only the second injector injects the reducing agent, the heating element then being deactivated by not heating the exhaust gases circulating in the conduit.

17. An exhaust gas purification device comprising a conduit defining an exhaust gas flow passage for exhaust gas, the conduit having an upstream end and a downstream end and being shaped to conduct exhaust gas from the upstream end to the downstream end, the exhaust gas purification device comprising:
at least two purification units, with each purification unit being arranged in the conduit, and wherein the at least two purification units comprise at least an upstream purification unit and a downstream purification unit;
an upstream purification component arranged in the exhaust gas flow passage of the upstream purification unit;
a downstream purification component arranged in the exhaust gas flow passage of the downstream purification unit;
at least one mixer arranged upstream of at least one of the upstream purification component and downstream purification component;
at least a first injector and a second injector, each of the first and second injectors arranged to inject a reducing agent into the exhaust gas flow passage;
a heating element configured to heat the exhaust gases and the reducing agent, and wherein at least one of the upstream and downstream purification units include the heating element; and
wherein the heating element is arranged between the upstream and downstream purification components and is upstream of the at least one mixer of the downstream purification unit.
